(19) United States
(12) Patent Application Publication
(10) Pub. No.: US 2018/0002037 A1
(43) Pub. Date: Jan. 4, 2018

(54) INTEGRATED MOBILE GROUND SUPPORT SYSTEM FOR SERVICING AIRCRAFT

(71) Applicant: John Bean Technologies Corporation, Chicago, IL (US)

(72) Inventors: Steven U. Nestel, Ogden, UT (US); Scott B. Gwilliam, Salt Lake City, UT (US); Pete James Menke, Woods Cross, UT (US); Brent Andrew Carlson, Ogden, UT (US); Randall A. Melancon, Ogden, UT (US); Krzysztof Kubica, South Ogden, UT (US)

(73) Assignee: John Bean Technologies Corporation, Chicago, IL (US)

(21) Appl. No.: 15/197,495

(22) Filed: Jun. 29, 2016

(51) Int. Cl. B64F 1/36; F04D 17/10; F04C 29/00; F04C 18/16; F04B 35/00; F04D 25/02; F02B 63/04

(52) U.S. Cl. CPC B64F 1/364; F04D 25/02; F04D 17/10; F02B 63/04; F04C 18/16; F04B 35/002; F04C 29/0085

(57) ABSTRACT

An integrated mobile ground support system 10 includes a wheeled cart 12 on which is mounted a power plant 14 to power an air compressor 16 to provide bleed air to an aircraft. The power plant 14 also powers an electrical generator 22, the output of which is controlled and converted to AC and/or DC power to meet the power requirements of the aircraft. An air conditioning unit 20 is also mounted on the cart 12 for providing conditioned air to the aircraft.

### BACKGROUND

Aircraft, when at a terminal or otherwise on the ground, require utility support of various types especially when the aircraft engines are not powered up. One utility need is electrical power in the form of alternating current (AC) power at various frequencies and voltages and/or direct current (DC) power at various voltages. The required voltages and other parameters of the electrical power differ from aircraft to aircraft.

Aircraft on the ground also require bleed air. Bleed air is high pressure air used by aircraft to operate onboard environmental control systems and to start gas turbine engines. When in flight, bleed air is siphoned off of the compressor stage of the aircraft engine, but this source of bleed air is not available when the aircraft is on the ground and de-powered.

A third utility need for aircraft on the ground is conditioned air, including for the cockpit and the cabin, as well as to provide cooling or heating to onboard electrical systems.

To date, the foregoing three utility functions have been fulfilled by individual pieces of ground supported equipment (GSE). In this regard, individual utility carts, for ground power, are commercially available. Such utility carts are typically powered by an internal combustion engine. The engine is paired with an electrical generator. The power from the generator must be converted to the correct type of power (AC/DC) at the correct power parameters through the use of a converter system. Typically, such power generators are relatively large and thus are mounted on a cart as a singular or separate equipment unit.

Bleed air has also typically been provided using a singular utility cart on which is mounted an internal combustion engine and a large screw-type compressor in order to provide air at a sufficient pressure and volume to meet aircraft needs, including for starting the aircraft engines. For example, bleed air is supplied at 150 pounds of air per minute at 50 psia.

Air conditioning units also typically have been mounted on individual carts. The units are powered by an internal combustion engine paired with a refrigerant-based air conditioning system. The components required for a refrigerant-based system are numerous, thereby occupying large volumes and thus commonly requiring a separate cart. Air cycle air conditioning systems have also been developed wherein pressurized air is supplied to the air cycle machine for further compression and then rapid cooling by expansion before being supplied to the aircraft. In these situations, the compressed air supplied to the air cycle machine originates from an external compressed air source, typically a large central compressor plant located at the airport.

There has been some attempt to seek to combine utility supply for aircraft, including for example providing both power and conditioned air to an aircraft. Such units utilize a diesel driven or electric motor driven power plant mounted on a cart to power both an air conditioning system and an electrical generator. However, such systems do not also provide bleed air for aircraft.

The present disclosure seeks to provide an integrated, singular modular cart that provides three utility needs for aircraft including electrical power, air conditioning, and bleed air thereby eliminating the requirement for multiple ground support carts by replacing heretofore three individual ground support carts with a singular unit.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An integrated ground support system for aircraft provides pressurized air, conditioned air, as well as electrical power in a singular assembly. The support system includes a power plant mounted on a frame to produce power to operate the ground support system. In this regard, the power plant powers an air compressor, also mounted on the frame, to produce compressed air for use by the aircraft. A drive train interconnects the power plant to the air compressor to power the air compressor.

The power plant also powers an electrical generator mounted on the frame to produce electrical power used by the aircraft. A drive train interconnects the power plant to the electrical power generator.

In addition, an air conditioner is mounted on the frame to produce conditioned air for use by the aircraft. Depending on the type of air conditioner, the air conditioner may also be powered by the power plant.

In a further aspect of the present disclosure, the frame on which the power plant, air compressor, air conditioner and electrical generator are all mounted, forms part of a portable, wheeled chassis. The size of the chassis, and thus the integrated ground support system, is designed to enable the chassis to be moved about an airport, an airfield, or an aircraft hangar so as to be put into position relative to the aircraft being supported.

In a further aspect of the present disclosure, the power plant may be an internal combustion diesel engine, an internal combustion gasoline engine, or an electrical motor.

In a further aspect of the present disclosure, the air compressor may be a screw-type air compressor, a centrifugal air compressor, or a piston-type air compressor. The drive train interconnecting the power plant to the air compressor can be configured to increase the rotational output speed of the power plant to drive the air compressor at a higher rotational speed than the output speed of the power plant. This is especially true if the air compressor is a centrifugal-type air compressor, which typically operates at a much higher rotational speed than the output of a power plant in the form of an internal combustion engine.

In accordance with a further aspect of the present disclosure, if the air conditioner is an air cycle-based air conditioner, pressurized air is transmitted from the air compressor to the air cycle-based air conditioner where the intake air from the air compressor is further compressed and then expanded to rapidly cool the air for use by the aircraft.

In a further aspect of the present disclosure, the power generator is either a direct current generator or an alternating current generator. The power converter is employed to convert the power generated by the power generator into direct current of selected parameters and/or alternating current of selected parameters.

In accordance with a further aspect of the present disclosure, a cooling system is provided for controlling the operational temperature of the air compressor, the air conditioner, and/or the electrical power generator. A singular cooling unit may be used for all three of these functions, or the cooling functions may be carried out by more than one cooling unit.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic view of a utility cart on which three separate utilities for servicing an aircraft are provided, including bleed air, conditioned air, and electrical power;

FIG. 2 is a schematic diagram of the integrated ground support system of the present disclosure utilizing an air cycle air conditioner unit for generating conditioned air;

FIG. 3 is a schematic view of a ground support system similar to FIG. 2, but with the conditioned air provided by a refrigerant-based system.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “top,” “bottom,” “right hand,” “left hand,” “in,” “out,” “extended,” “advanced,” “retracted,” “proximal,” and “distal.” These references and other similar references in the present application are only to assist in helping describe and understand the present invention and are not intended to limit the present invention to these directions.

The present application may include modifiers such as the words “generally,” “approximately,” “about”, or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the following description, various embodiments of the present disclosure are described. In the following description and in the accompanying drawings, the corresponding systems assemblies, apparatus and units may be identified by the same part number, but with an alpha suffix. The descriptions of the parts/components of such systems assemblies, apparatus, and units that are the same or similar are not repeated so as to avoid redundancy in the present application.

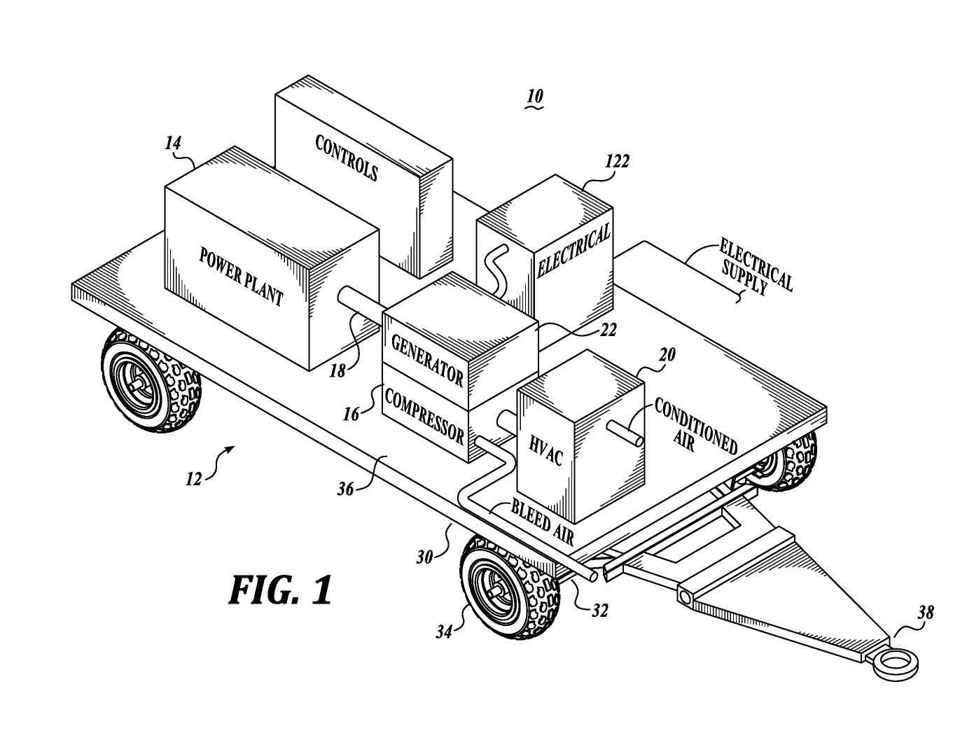

Referring initially to FIG. 1, an integrated ground support system 10 provides utilities to aircraft on the ground, including pressurized air, conditioned air, and electrical power. The system 10 is configured as a singular assembly mounted on a cart 12. The integrated ground support system includes a power plant 14 mounted on chassis 30 for producing power to operate the ground support system 10. An air compressor 16 is also mounted on the chassis 30 to produce compressed air for the aircraft. A drive train 18 interconnects the power plant to the air compressor. An air conditioner system 20 is mounted on the chassis 30 to produce conditioned air for the aircraft. An electrical generator 22, powered by the power plant, is also mounted on the chassis 30 to produce electrical power for the aircraft. The drive train 18 connects the power plant to the electrical power generator. The foregoing aspects of the present disclosure are described more fully below.

Referring specifically to FIG. 1, the cart 12 includes a chassis 30 composed of an underlying frame 32 mounted on wheels 34. The chassis also includes platform 36 on which the components of the integrated ground support system 10 are mounted. A tow bar 38 is provided to enable the cart 12 to be easily moved from place to place. The cart 12 can be of various constructions, but ideally is relatively compact in size, especially for its function of carrying and supporting power plant 14, air compressor 16, air conditioner 20, as well as electrical generator 22. In this regard, the chassis 30 can be constructed to have a maximum length of about from 100 inches to 150 inches and a maximum width of about from 66 inches to 96 inches. Also, in keeping with the small envelope of the integrated ground support system 10, the maximum height of the ground support system may be from about 60 inches to 96 inches. Of course, the foregoing dimensions may be greater or less than the designated specific dimensions and still provide a cart that provides all the functions of the integrated ground support system 10 of the present disclosure while also being portable and small enough to be used in supporting aircraft, including on crowded airfields.

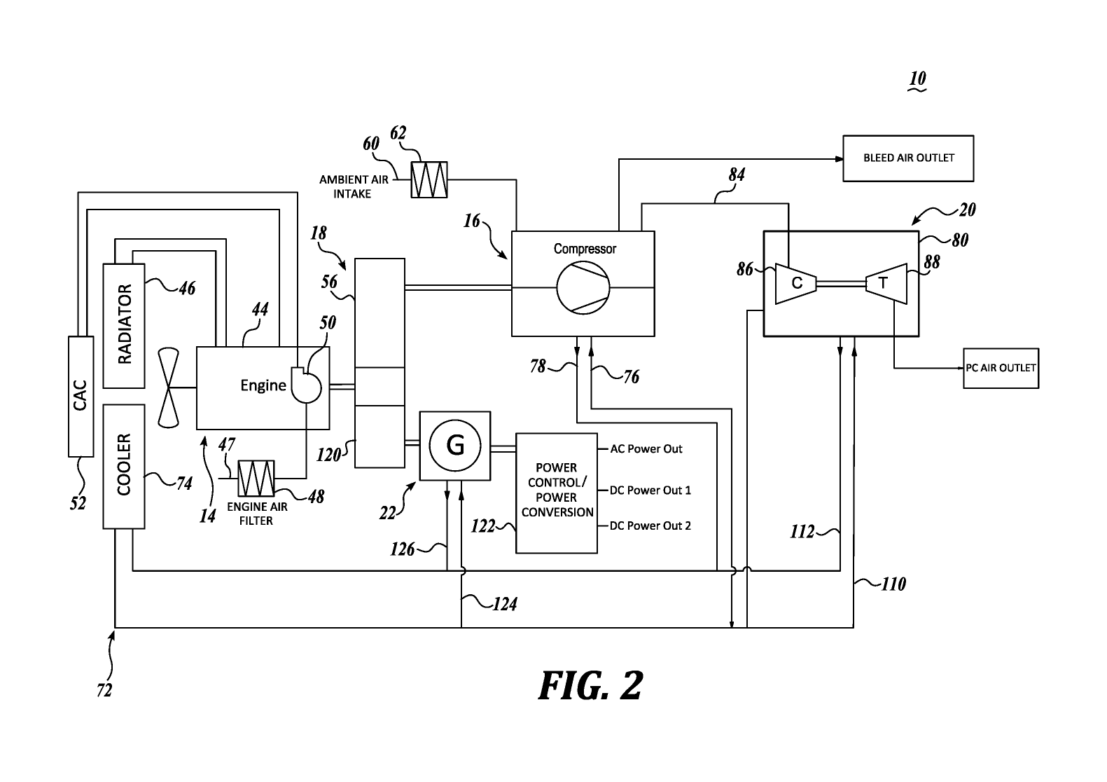

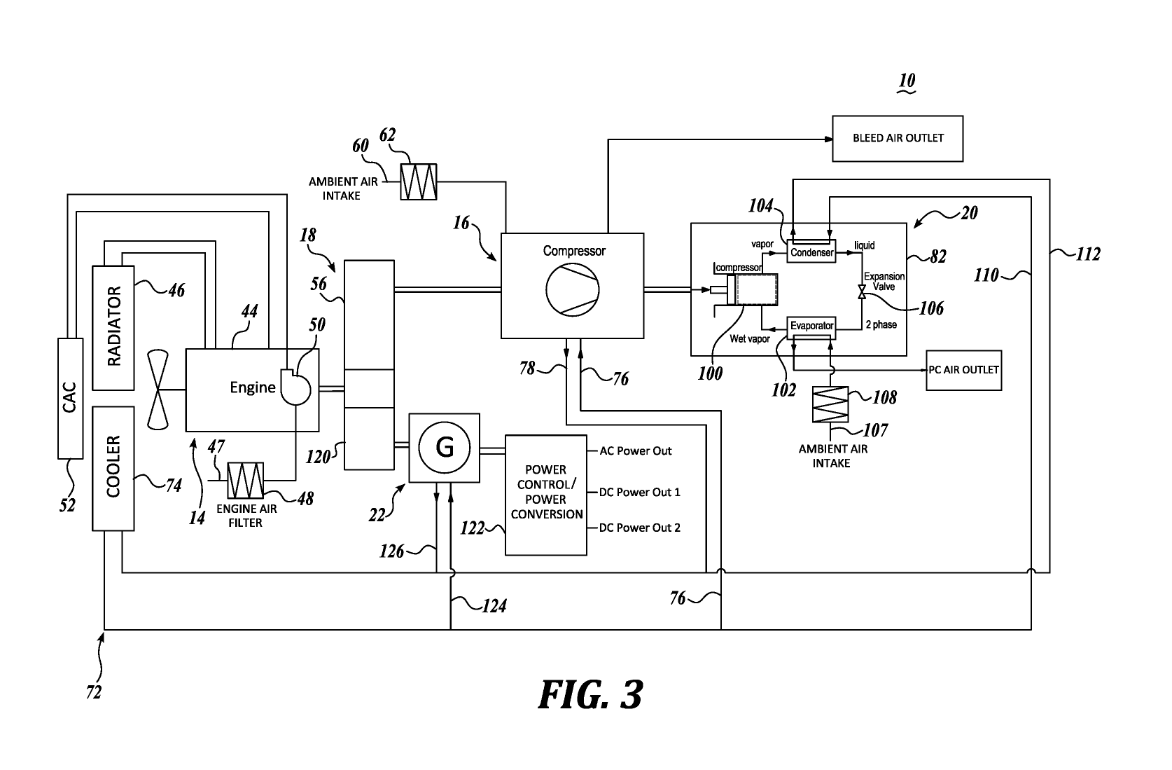

The power plant 14 can be of various constructions, including an internal combustion engine 44 schematically illustrated in FIGS. 2 and 3. The internal combustion engine 44 may be a diesel fueled engine or a gasoline fueled engine and of sufficient size to readily power the ground support system but also to provide reasonable fuel economy. Such diesel and gasoline driven internal combustion engines to serve as the power plant 14 are articles of commerce. The power plant may also be in the form of an electrical motor, which draws electrical power from an airport source, perhaps located adjacent an airport terminal gate or aircraft hangar.

Referring to FIGS. 2 and 3, if an internal combustion engine is utilized, typically the engine will require a radiator 46 to provide cooling for the engine. Also, to help ensure operation of the engine 44 with minimal maintenance, a robust air intake system is provided which includes an air intake 47 leading to an air filter unit 48 located upstream from a turbo blower 50 that directs the intake air through a charge air cooler (CAC) 52 to cool the air before being directed to the intake system of the engine 44. The turbo blower 50 is driven by the engine exhaust gas in a standard manner. Power plants, such as engine 44, are capable of a long reliable service life with minimal maintenance, for example, primarily only periodically changing the air filter and the engine oil and engine oil filter.

The compressor 16 may be of various types, including piston-type compressor, a screw-type compressor, or a centrifugal compressor, all of which are articles of commerce. Drive train 18 interconnects the compressor with the rotational output of the engine. Depending on the type of compressor utilized, the rotational speed of the engine output may need to be stepped up by the drive train. For example, if a centrifugal compressor is utilized, such compressor commonly operators in the speed range of about 24000 to 43000 rpm. However, for long life, the engine 44 typically operates at a speed of about 1300 to 2300 rpm. Thus, the transmission of the drive train 18 must increase the speed of the engine output considerably to drive the centrifugal compressor at its operational speed. In this regard, a multi-stage transmission may be employed. On the other hand, if the compressor is a screw-type compressor or a piston-type compressor, the output speed of the engine 44 need not be increased to nearly the rotational speed of a centrifugal compressor.

Referring to FIGS. 2 and 3, the compressor 16 includes an ambient air intake 60 wherein the ambient air flows first through a filter 62, and then into the intake of the compressor 16. The compressor 16 produces bleed air for the aircraft at desired parameters, for example, at a pressure of about 48 psig, at 100 to 150 pounds per minute, and at a temperature of about 340° F. The pressure and temperature of the output can be monitored by appropriate sensing devices, not shown.

A cooling system 72 is provided for controlling the operational temperature of the compressor 16. The cooling system includes a cooler or heat exchanger 74 interconnected with the compressor 16 by lines 76 and 78 that route a cooling medium from the heat exchanger 74 to the compressor 16 and then from the compressor back to the heat exchanger 74.

Various types of air conditioning systems may be utilized with the ground support system 10. FIG. 2 schematically illustrates an air conditioner in the form of an air cycle air conditioner or machine 80, whereas FIG. 3 schematically illustrates refrigerant-based air conditioner 82. Initially referring to FIG. 2, the air cycle air conditioner 80 receives compressed air from the compressor 16 through line 84. Such intake air is further compressed by a compressor 86 and then expanded, and thereby cooled in a turbine 88. The air cycle machine 80 is capable of producing conditioned air for the aircraft at desired parameters, for example, at a temperature of approximately 34° F. to 40° F. and at a volume of 55-100 pounds per minute at a pressure of about 4 to 5 psig.

The outlet pressure and temperature of the conditioned air can be monitored by applicable pressure and temperature meters. It will be appreciated that air cycle machine 80 is powered by the compressed input air entering the air cycle machine through line 84. No separate power or drive system is required for the operation of the air cycle machine 80.

Referring to FIG. 3, the air conditioner 82 is schematically depicted as a refrigerant-based configuration. The air conditioner 82 in this regard includes a compressor 100 for compressing the refrigerant in vapor form exiting evaporator 102. The compressor compresses the vapor sufficiently so that at condenser 104, when heat from the compressed vapor is expelled to the ambient, the cooling medium transforms into liquid form. The cooling medium is then routed to an expansion valve 106 which expands the liquid refrigerant into a liquid/vapor mixture and substantially cools the refrigerant prior to entering evaporator 102. At the evaporator 102, ambient air is significantly cooled by giving off heat to the refrigerant in the evaporator prior to the ambient air being routed to the aircraft. The ambient air enters air intake 107 and then flows through air filter 108 prior to reaching the evaporator 102. The refrigerant-based air conditioner 82 shown in FIG. 3 is of a “direct expansion” type, since the air supplied to the aircraft is directly cooled by the evaporator 102 after the refrigerant has been expanded by valve 106. A fan, not shown, is used to circulate the air through the filter 108, the evaporator 102, and then to the aircraft.

Cooling system 72 controls the operational temperature of the air cycle machine 80 and refrigerant-based air conditioner 82 shown in FIGS. 2 and 3. In this regard, direct the coolant medium from the cooler 74 to and from the air cycle machine 80 and the condenser of the refrigerant-based air conditioner 82, as illustrated in the figures.

The electrical generator 22 is powered by the engine 44 through the use of the drive train 18. A transmission 120 speeds up the rotational output from the engine 44 for the operation of the generator 22. The generator 22 can be of various types, including an alternating current generator or a direct current generator, which are articles of commerce. Regardless of the type of generator utilized, a power control/power conversion system 122 converts the output from the generator 22 to provide power to the aircraft having specific parameters. An example of one such parameter set may be three phase AC power at: 400 Hz; 60 kW to 90 kW; and either 120 or 208 Volts. Other power parameters may be utilized, for example, the AC power may be at approximately 115 or 200 Volts.

DC power may be provided at various parameters, such as at 270 Volts at a level of 72 kW. Another example of DC power parameters produced by the power control/power conversion system 122 is: 28 Volts at 500 amps continuously, or 1500 amps for 5 minutes. The point is that different aircraft have different power requirements and that the power control/power conversion system 122 is capable of producing AC and/or DC power at the required parameters. One form of power control/power conversion system 122 that may be utilized with integrated ground support system 10 is disclosed in co-pending U.S. patent application Ser. No. 15/197,460, incorporated herein by reference.

The cooling system 72 may be also used to control the operational temperature of the generator 22. In this regard, lines 124 and 126 direct the coolant medium to and from the generator 22, as shown in the FIGURES. It will be appreciated that although one cooling system 74 is illustrated, more than one cooling system may be employed to control the operational temperatures of compressor 16, air conditioning system 20, and electrical generator 22.

As will be appreciated, the foregoing describes an integrated ground support system 10 mounted on a singular cart 12. During the operation of the system 10, if an air cycle machine 80 is utilized for providing air conditioning to the aircraft, then the bleed air system is not operated simultaneously with the air cycle machine because the air cycle machine utilizes the compressed air from compressor 16 for its operation. Also, typically, AC and DC power is not provided simultaneously via the power control/power conversion system; rather, either DC or AC power is provided by the system.

While illustrative embodiments have been illustrated and described, it will be appreciated that various changes can be made therein without departing from the spirit and scope of the invention. In this regard, although example parameters have been set forth in above for the bleed air, conditioned air, and electrical supply produced by the ground support system 10, the system 10 can supply bleed air, conditioned air, and electrical supply at other parameters.

The embodiments of the invention in which an exclusive property or privilege is claimed are defined as follows:

1. An integrated ground support system for aircraft to provide pressurized air, conditioned air, and electrical power to aircraft, the integrated ground support system comprising:
a frame on which the integrated ground support system is arranged as a singular assembly;
a power plant mounted on the frame, the power plant producing power to operate the ground support system;
an air compressor mounted on the frame to produce compressed air for use by the aircraft;
a drive train interconnecting the power plant to the air compressor to power the air compressor;
an air conditioner mounted on the frame to produce conditioned air for use by the aircraft;
an electrical power generator mounted on the frame to produce electrical power for use by the aircraft; and
the drive train interconnecting the power plant to the electrical power generator to power the electrical generator.

2. The integrated ground support system according to claim 1, wherein the power plant is selected from the group consisting of:
an internal combustion diesel engine;
an internal combustion gasoline engine; and
an electric motor.

3. The integrated ground support system according to claim 1, wherein the air compressor is selected from the group consisting of a screw-type compressor, a centrifugal compressor, a piston-type compressor.

4. The integrated ground support system according to claim 1, wherein:
the power plant producing a rotational output; and
the drive train comprising a first transmission for increasing the rotational output speed of the power plant to drive the air compressor at a higher rotational speed than the rotational output speed of the power plant.

5. The integrated ground support system according to claim 1, further comprising a cooling system for controlling the operational temperature of the air compressor, the cooling system comprising a cooling unit and transfer lines for circulating a cooling fluid between the cooling unit and the air compressor.

6. The integrated ground support system according to claim 1, wherein the air conditioner is selected from the group consisting of a refrigerant-based air conditioner and an air cycle-based air conditioner.

7. The integrated ground support system according to claim 6, wherein pressurized air is transmitted from the air compressor to the air cycle-based air conditioner, and the air cycle-based air conditioner further compressing the pressurized air from the air compressor and then expanding the compressed air to cool the compressed air for use by the aircraft.

8. The integrated ground support system according to claim 1, wherein the drive train is functionally connected to the air conditioner to power the air conditioner via the power plant.

9. The integrated ground support system according to claim 1, further comprising a cooling system for controlling the operational temperature of the air conditioner, the cooling system comprising a cooling unit and transfer lines for circulating a cooling medium between the cooling unit and the air conditioner.

10. The integrated ground support system according to claim 1, wherein the power generator is selected from the group consisting of a direct current generator and an alternating current generator.

11. The ground support system according to claim 10, further comprising a power converter to convert the power generated by the power generator into direct current of selected parameters and/or alternating current of selected parameters.

12. The integrated ground support system according to claim 11, wherein the power converter converts the power generated by the power generator into: alternating current at one or more desired voltages and one or more desired frequencies; and direct current at one or more desired voltages.

13. The integrated ground support system according to claim 10, wherein:
the power plant producing a rotational output; and
the drive train comprising a speed up transmission for increasing the rotational speed outputted by the power plant to drive the power generator at a higher rotational speed than the output speed of the power plant.

14. The integrated ground support system according to claim 1, further comprising a cooling system for controlling the operational temperature of the power generator, the cooling system comprising a cooling unit and transfer lines for routing a cooling medium between the cooling unit and the power generator.

15. The integrated ground support system according to claim 1, wherein the frame is mounted on a mobile chassis on which the power plant, the air compressor, the air conditioner, and the electrical power generator are mounted.

16. The integrated ground support system of claim 15, wherein the chassis has a maximum length in the range of about 100 inches to 150 inches and a maximum width in the range of about 66 inches to 96 inches.

17. The integrated ground support system of claim 16, wherein the envelope of the ground support system has a maximum height in the range of about 60 inches to 96 inches.

18. A mobile integrated ground support system for aircraft to provide pressurized air, conditioned air, and electrical power to aircraft, the integrated ground support system comprising:
a portable wheeled chassis on which the integrated ground support system is arranged as a singular assembly;
a power plant mounted on the chassis, the power plant producing power to operate the ground support system;
an air compressor mounted on the chassis to produce compressed bleed air for use by the aircraft;
a drive train interconnecting the power plant to the air compressor to power the air compressor at an operational speed;
an air conditioner mounted on the chassis to produce conditioned air for use by the aircraft, the air conditioner driven by the air compressor or the power plant;
an electrical power generator mounted on the chassis to produce electrical power for use by the aircraft; and
the drive train interconnecting the power plant to the electrical power generator to power the electrical generator.

19. The mobile integrated ground support system according to claim 18, wherein the power plant is selected from the group consisting of:
an internal combustion diesel engine;
an internal combustion gasoline engine; and
an electric motor.

20. The mobile integrated ground support system according to claim 18, wherein:
the air compressor is selected from the group consisting of a screw-type compressor, a centrifugal compressor, a piston-type compressor;
the air conditioner is selected from the group consisting of a refrigerant-based air conditioner and an air cycle-based air conditioner; and
the power generator is selected from the group consisting of a direct current generator and an alternating current generator.
